(19) United States
(12) Patent Application Publication
(10) Pub. No.: US 2024/0182279 A1
(43) Pub. Date: Jun. 6, 2024

(54) SYSTEM AND METHOD FOR LIFTING AND ORIENTING A CHAMBER

(71) Applicant: FUJIFILM Irvine Scientific, Inc., Santa Ana, CA (US)

(72) Inventors: Jose SAN ANDRES, Santa Ana, CA (US); Thomas Reid FLETCHER, Newport Beach, CA (US); James PEERENBOOM, Santa Ana, CA (US)

(73) Assignee: FUJIFILM Irvine Scientific, Inc., Santa Ana, CA (US)

(21) Appl. No.: 18/529,976

(22) Filed: Dec. 5, 2023

Related U.S. Application Data
(60) Provisional application No. 63/430,625, filed on Dec. 6, 2022.

(51) Int. Cl. B66F 3/14

(52) U.S. Cl. CPC B66F 3/14

(57) ABSTRACT

A lift device includes a first rail guide coupled vertically to a support wall, a rail coupled to the first rail guide, and a carrier plate coupled to the rail by at least one linear bearing rail block coupled to the carrier plate and the rail. The at least one linear bearing rail block is configured to move along a length of the rail. The lift device further includes a threaded drive shaft extending parallel to the first rail guide, through the carrier plate, and coupled to the carrier plate at a top edge and a bottom edge of the carrier plate, and a drive motor coupled with the drive shaft, wherein the drive motor drives movement of the carrier plate along the drive shaft. The lift device may further include a rotating mechanism configured to move the cylindrical cartridge from a first orientation to a second orientation.

### CROSS-REFERENCE TO RELATED APPLICATIONS

This application claims the benefit of and priority to U.S. Provisional Patent Application Ser. No. 63/430,625 filed Dec. 6, 2022, which is hereby incorporated by reference in its entirety.

### BACKGROUND

The present disclosure relates generally to a lift device for changing a position and/or orientation of a chamber. More specifically, the present disclosure relates to a lift device that changes a position and orientation of a mixing chamber that is part of a mixing apparatus.

Reconstitution of powdered cell culture media into liquid media may be performed using a mixing apparatus including, for example, one or more fluid sources, an array of tubes, a plurality of valves, and one or more mixing chambers. The mixing chamber may be a single use apparatus, and may be provided with necessary media components (e.g., powdered cell culture media, sodium bicarbonate, etc.) prepackaged therein. The chamber may also be reusable. Typically, a mixing chamber is very heavy and is not easily manipulated by a person working alone. Furthermore, the mixing chamber must be supported relative to the mixing apparatus during processing, which involves filing the chamber with fluid, causing the chamber to become even heavier. Accordingly, a lifting device may be used to assist with lifting and holding the mixing chamber for use during reconstitution of powdered cell culture media.

Due to its significant mass and for ease of transport, a mixing chamber may be presented for use laying flat on a rolling cart. Accordingly, the chamber needs to be rotated to a vertical position for use with the mixing apparatus. Furthermore, present designs of lifting devices suffer from significant oscillations among the components, causing unpleasant and potentially harmful noise levels.

### BRIEF DESCRIPTION OF THE FIGURES

FIG. 1 is a side view of a mixing apparatus, according to an exemplary embodiment.

FIG. 2 is a perspective view of the mixing apparatus of FIG. 1.

FIG. 3 is a front perspective view of a lift device, according to an exemplary embodiment.

FIG. 4 is a rear perspective view of the lift device of FIG. 1, with the carrying basket removed.

FIG. 5 is a rear perspective view of the lift device of FIG. 1, with the carrying basket shown in a vertical orientation.

FIG. 6 is a front plan view of the lift device of FIG. 1, with the housing removed.

FIG. 7 is a rear plan view of the lift device of FIG. 1, with the housing removed.

FIG. 8 is a front, top perspective view of the lift device of FIG. 1, with the housing removed.

FIG. 9 is front perspective view of components of the lift device of FIG. 1

FIG. 10 is a rear perspective view of components of the lift device of FIG. 1.

FIG. 11 is a front perspective view of a lift system of the lift device of FIG. 1, according to an exemplary embodiment.

FIG. 12 is a top, front perspective view of a carrier plate of the lift device of FIG. 1, according to an exemplary embodiment.

FIG. 13 is a rear perspective view of the carrier plate of FIG. 12.

FIG. 14 is a bottom, rear perspective view of the carrier plate of FIG. 12.

FIG. 15 is a rear perspective view of the lift system of FIG. 11.

FIG. 16 is a rear perspective view of the lift device of FIG. 1, showing components of a rotating system.

FIG. 17 is a rear perspective view of components of the rotating system of the lift device.

FIG. 18 is a front perspective view of components of the rotating system of the lift device.

FIG. 19 is a flow chart depicting a method of hydrating a dry culture media or other powders using a lift device according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

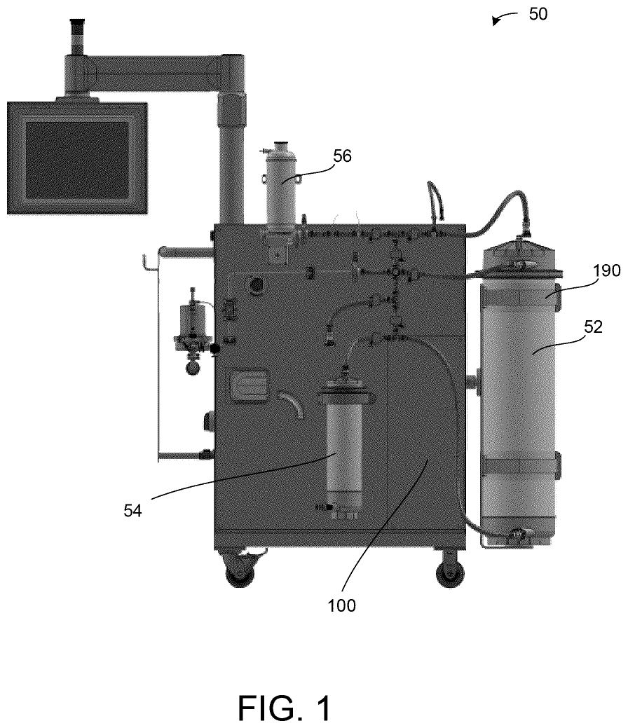

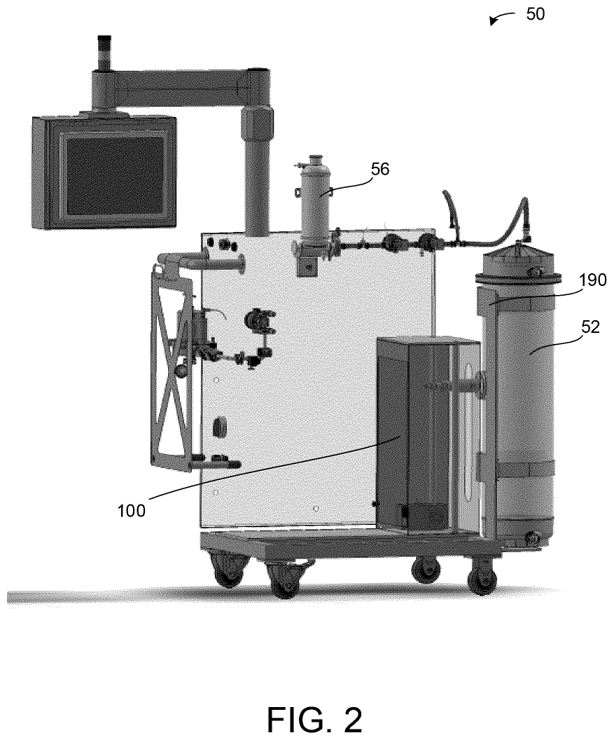

Referring to FIGS. 1 and 2, a mixing apparatus 50 is shown according to an exemplary embodiment. According to an embodiment, the mixing apparatus is a mixing apparatus as shown and described in U.S. Pat. No. 11,097,237 entitled “Automated Method and Apparatus for Preparing Bioprocess Solutions” filed Jun. 25, 2018, which is hereby incorporated by reference herein in its entirety. In an embodiment, the mixing apparatus 50 can be formed of materials that are appropriate for a cell culture environment, for example non-toxic, medical grade plastics or other non-toxic materials that will not contaminate a media. In an exemplary embodiment, the mixing apparatus 50 is configured for reconstitution of powdered cell culture media into liquid media. In one example, the mixing apparatus 50 includes at least one mixing chamber. The chamber may be a single use apparatus, and may be provided with necessary media components (e.g., powdered cell culture media, sodium bicarbonate, etc.) prepackaged therein. In some embodiments, the mixing apparatus 50 is used to reconstitute other forms of undissolved cell culture media (e.g., granulated cell culture media), prepare bioprocessing buffers from a dry format, or more generally reconstitute liquids from powders. In some embodiments, the mixing chamber may include one or more features to facilitate dissolution of powdered media such as stir bars, impellers, flow regulators, and geometric flow aids.

In an exemplary embodiment, the mixing apparatus 50 includes a first mixing chamber 52, a second mixing chamber 54, and a filter unit 56. The mixing chamber may be any embodiment of a mixing chamber as described in U.S. Pat. No. 11,097,237 entitled “Automated Method and Apparatus for Preparing Bioprocess Solutions” filed Jun. 25, 2018 or U.S. Pat. No. 10,150,941, entitled “Media Mixing Chamber”, each of which is incorporated by reference herein in its entirety. The first mixing chamber 52, the second mixing chamber 54, and the filter unit 56 can be communicably coupled via various lengths of tubing (e.g., flexible hoses). The tubing can further include valves (e.g., pinch valves, ball valves, etc.), for example, for selectively controlling a flow of fluids through the mixing apparatus 50. The first mixing chamber 52 can be configured to house one or more media, for example a dry powder to be reconstituted into a liquid media. The second mixing chamber 54 can also be configured to house one or more media, for example an additive (e.g., sodium bicarbonate powder, purified water, etc.) to be added to a cell culture media. In an exemplary embodiment, one or more fluids may flow into and out of the first mixing chamber 52 or the second mixing chamber 54 (e.g., via a reservoir, the first mixing chamber 52, the second mixing chamber 54, etc.), for example to facilitate reconstituting liquids from powders. Further, one or more fluids may flow into and out of the filter unit 56, and the filter unit 56 can be configured to filter solution flowing into the filter unit 56 (e.g., via a filtration tubing section) or vent gases from the fluids.

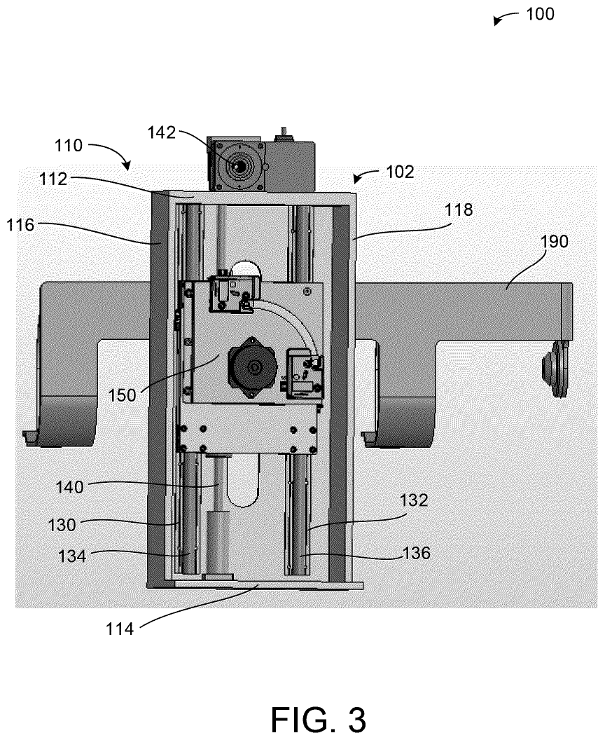

In an exemplary embodiment, the mixing apparatus 50 includes a lift mechanism or a lift device 100. The lift device 100 can be coupled with a carrying basket 190 to carry a chamber or vessel (e.g., cartridge, container, receptacle, etc.), or coupled directly to the chamber or vessel. The chamber or vessel may be cylindrical (e.g., a cylindrical cartridge) or another elongate shape. For example, the lift device 100 can be coupled with the first mixing chamber 52. In other embodiments, the lift device 100 may be coupled to a housing or frame configured to support large volumes of bagged media. In an exemplary embodiment, the lift device 100 is configured to position and/or orient a chamber (e.g., the first mixing chamber 52) relative to one or more components of the mixing apparatus 50. For example, and as will be discussed in greater detail below, the lift device 100 is configured to move a chamber or vessel vertically, for example from a first vertical position to a second vertical position (e.g., a first and second height off the support surface). The lift device 100 can also be configured to orient (e.g., rotate) a chamber or vessel, for example from a first orientation (e.g., a horizontal orientation) to a second orientation (e.g., a vertical orientation). In an exemplary embodiment, the lift device 100 is configured move a chamber vertically and change orientation of the chamber simultaneously, for example, to lift and change an orientation of the chamber in a single movement. In other embodiment, the lifting and changing the orientation may be performed independently. In an exemplary embodiment, the chamber is loaded onto the lift device in a horizontal orientation (as shown in FIG. 3) at a first lower position. The chamber is then rotated during (e.g., throughout lifting or at a specific location/time during the lifting) into a vertical orientation (as shown in FIGS. 1-2 and 5). When the lift device is at a second, highest position, the chamber is in a vertical orientation.

In an exemplary embodiment, the lift device 100 is configured to lift and/or rotate a chamber (e.g., a cylindrical cartridge, first mixing chamber 52, etc.) having a length, diameter, and a weight. In an exemplary embodiment, the length is between approximately 0.75-1.25 m, or between approximately 0.9 m-1.2 m, or between approximately 1.0 m-1.2 m, or approximately 1.07 m (42 inches), or no less than approximately 1.0 m. In an exemplary embodiment, the diameter includes an internal diameter of between approximately 20-50 cm, or 25 centimeter (10 inches). In an exemplary embodiment, the diameter includes an external diameter of between approximately 25-35 cm, or approximately 30 cm (12 inches), or at least approximately 3.8 cm (1.5 inches) greater than the internal diameter.

In an exemplary embodiment, the empty cartridge weighs between 5-10 kg, or approximately 6.5 kg. The cartridge may carry up to 50 kg of powder contents. The basket 190, in an exemplary embodiment, weighs between 15-20 kg, or 16 kg. The cartridge may hold approximately 20 kg of water during use. Accordingly, the lift device 100 is configured to lift between approximately 20-100 kg, or approximately 22.5 kg when the cartridge is empty, approximately 72.5 kg when the cartridge contains powder contents, and up to approximately 92.5 kg when the cartridge is further carrying water. In other embodiments, the lift device may be configured to carry up to 200 kg.

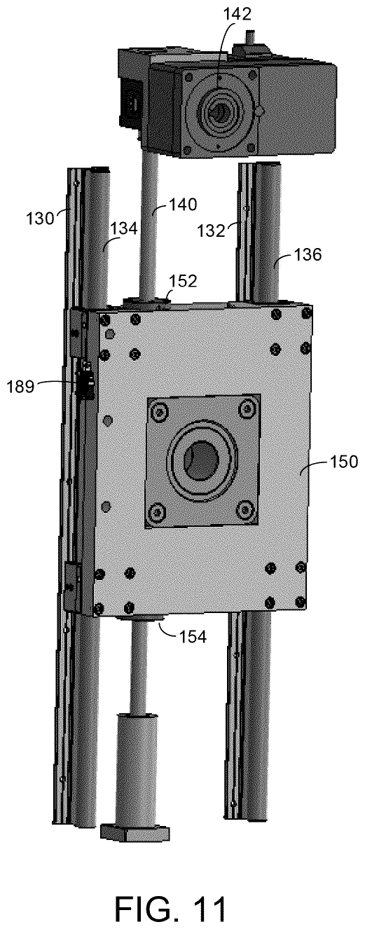

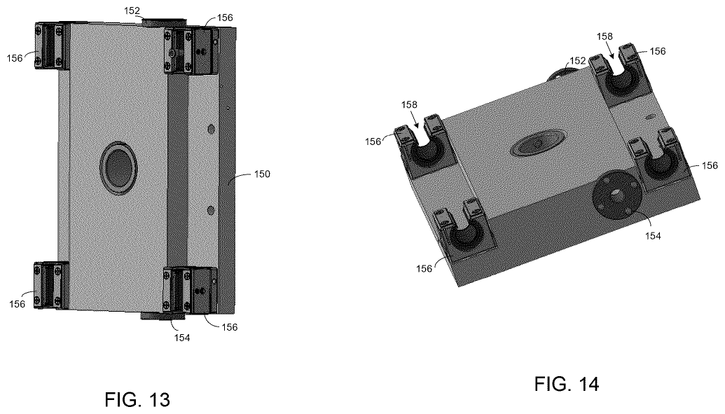

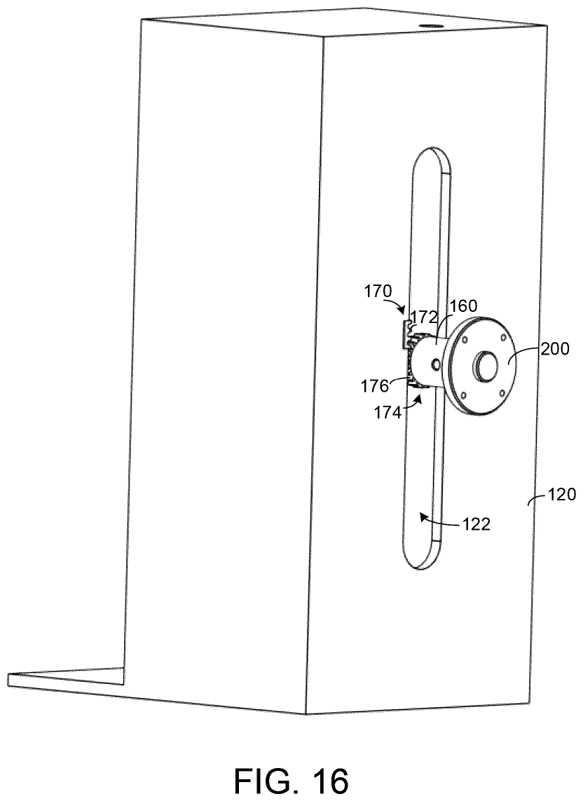

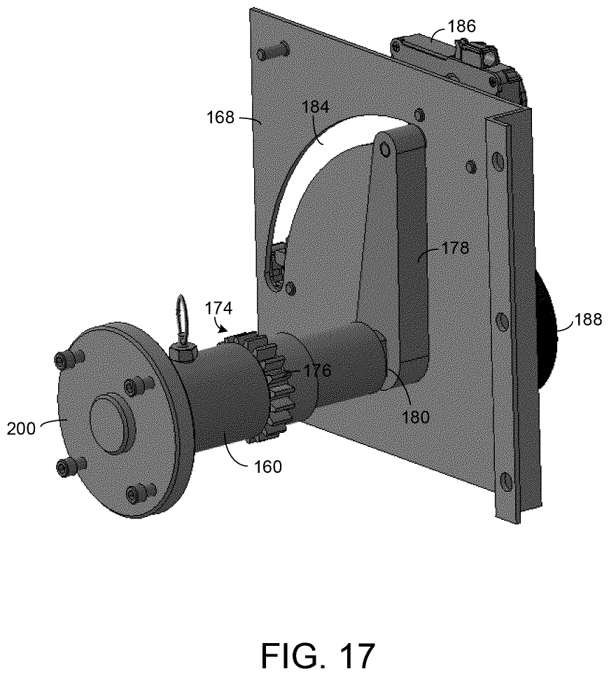

In an exemplary embodiment, the lift device 100 includes a lift system (discussed in greater detail below with reference to FIGS. 11-15). The lift system is configured to move a chamber, for example from a first vertical positon to a second vertical position. In an exemplary embodiment, the lift device 100 also includes a rotating system (as discussed in greater detail below with reference to FIGS. 16-18). The rotating system is configured to move (e.g., rotate, orient) a chamber, for example from a first orientation to a second orientation. As will be discussed in greater detail below, the lift system and the rotating system can be configured to work simultaneously, for example to lift and change an orientation (e.g., rotate) of a chamber. According to various exemplary embodiments described herein, the lift system and the rotating system are coupled to a basket 190 configured to support a chamber, such as a mixing chamber.

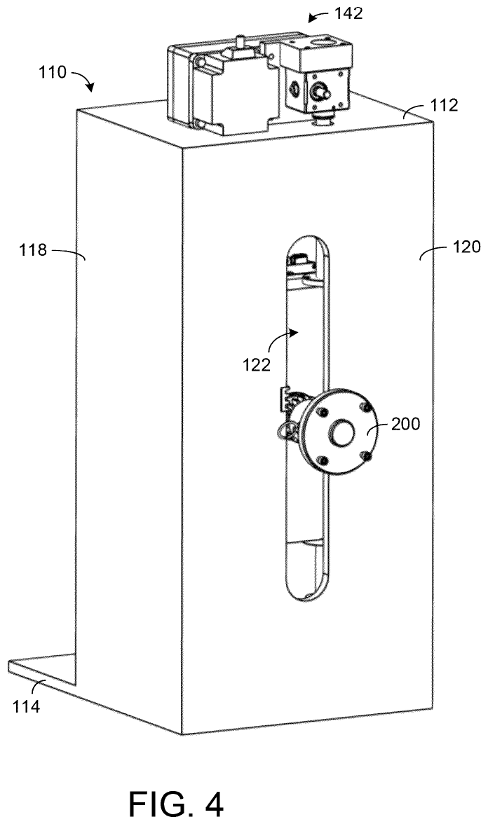

Referring to FIGS. 3-5, according to an exemplary embodiment, the lift device 100 includes a housing 110. The housing 110 can be formed of one or more walls or surfaces, and can be configured to house components of the lift device 100. For example, the housing 110 can include a top wall 112, a bottom wall 114, a first side wall 116, and a second side wall 118. The housing can further include a rear wall 120. In an exemplary embodiment, the top wall 112 is coupled with a top edge of the rear wall 120, and the bottom wall 114 is coupled with a bottom edge of the rear wall 120, such that the rear wall 120 extends (e.g., vertically) between the top wall 112 and the bottom wall 114. The first side wall 116 can be coupled with a first side edge of the rear wall 120, and the second side wall 118 can be coupled with a second side edge of the rear wall 120, such that the rear wall 120 extends (e.g., laterally) between the first side wall 116 and the second side wall 118. The top wall 112, the bottom wall 114, the first side wall 116, and the second side wall 118 can be coupled with the rear wall 120, for example at respective and complimentary edges, such that the walls 112-118 extend from the rear wall 120. An elongated slot 122 is formed in the rear wall 120 which allows passage of a shaft of the lift system and rotating system therethrough for coupling with the basket 190 or directly to a chamber. The shaft is able to rotate within the slot 122 and translate vertically along the slot 122. In some alternative embodiments, the lift device 100 includes fewer walls than described above. For example, the lift device may include only a rear wall 120 forming a support wall.

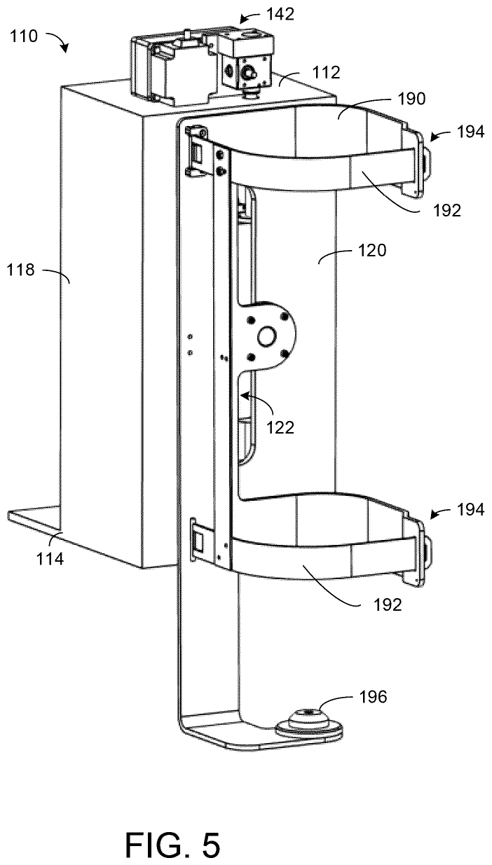

The basket 190 of the lift device 100, in some embodiments, includes one or more coupling components to secure the mixing chamber to the lift device 100. Coupling components may include straps 192 with locks 194 (such as the wedge type locks shown in FIG. 5) and a protrusion 196 (such as the retainer dome shown in FIG. 5) that couple to an indent formed on one side of the mixing chamber. While a dome shape is shown in FIG. 5, other shapes (e.g., a keyed coupling) are possible. In other embodiments, the mixing chamber may include a protrusion and the lift device may include an indent.

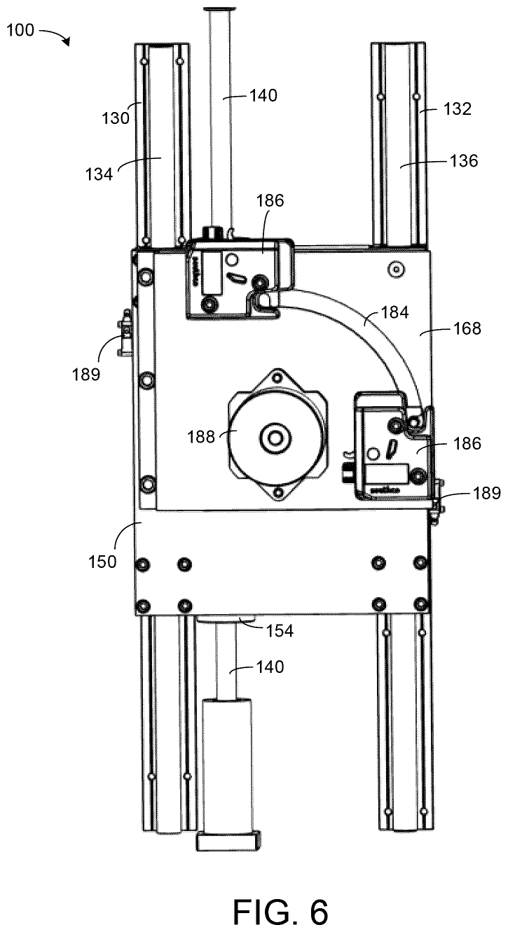

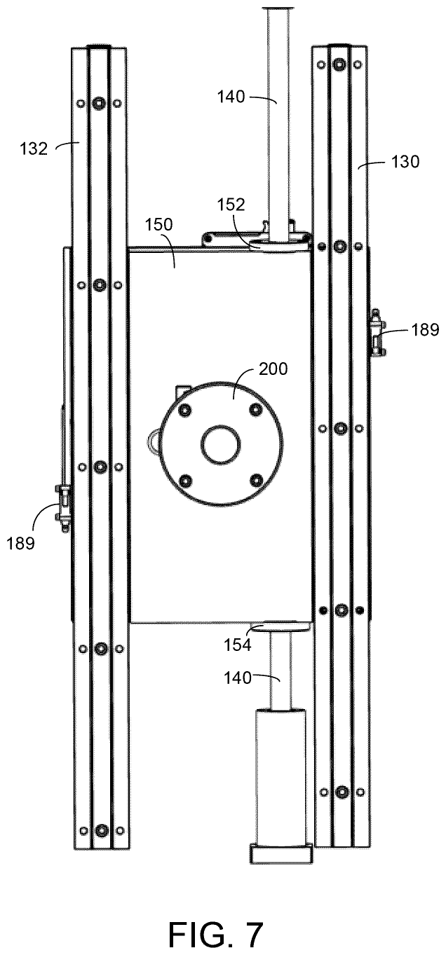

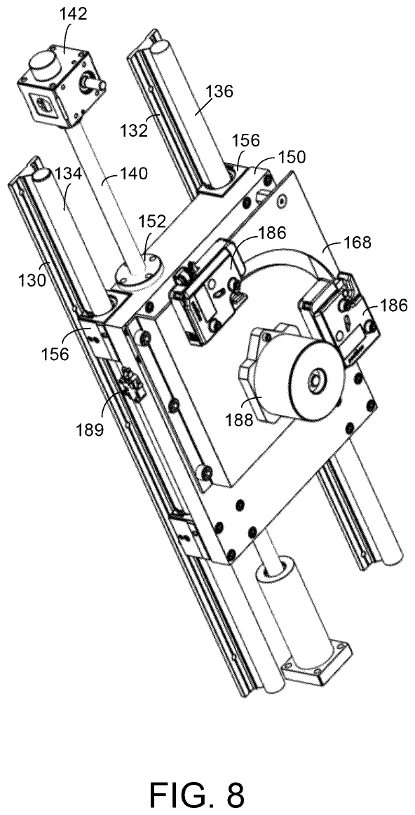

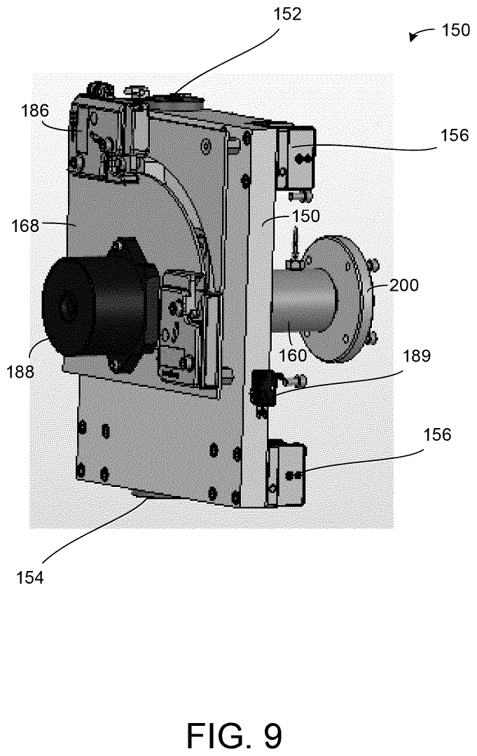

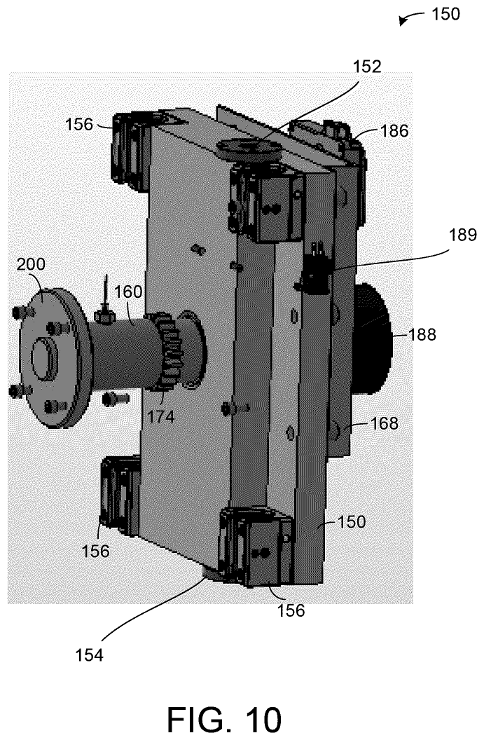

Referring now to FIGS. 6-10, portions of the lift device 100 are shown isolated from the housing 110. The lift device 100 includes the lift system and the rotating system, each including various components to execute its function. As shown, the lift device 100 includes a carrier plate 150 coupled to at least one rail 134, 136 and a drive shaft 140, allowing for a change the vertical position of the chamber. Coupled to the carrier plate 150 is a locking plate 168 which guides and secures the orientation of the chamber.

Referring now to FIG. 11, in an exemplary embodiment, the lift device 100 (e.g., the lift system) includes at least one rail guide. For example, the lift device 100 can include a first rail guide 130 and a second rail guide 132. The first rail guide 130 or the second rail guide 132 are configured to couple one or more components of the lift device 100 (e.g., a rail, bearing rail block, etc.), for example to support or stabilize components of the lift device 100 or components coupled thereto (e.g., a chamber). The first rail guide 130 and/or the second rail guide 132 can extend between walls of the housing 110. For example, the first rail guide 130 or the second rail guide 132 can extend (e.g., vertically, partially vertically) between the top wall 112 and the bottom wall 114 (as shown in at least FIG. 3). The first rail guide 130 and/or the second rail guide 132 may extend (e.g., span) the entire distance between the top wall 112 and the bottom wall 114, or may span only a portion of the distance between the top wall 112 and the bottom wall 114. The first rail guide 130 and the second rail guide 132 can be separated (e.g., laterally) by a distance.

In an exemplary embodiment, the first rail guide 130 or the second rail guide 132 are coupled to one or more walls of the housing 110. For example, the first rail guide 130 and/or the second rail guide 132 are coupled to a support wall (e.g., the rear wall 120). The first rail guide 130 and/or the second rail guide 132 may extend vertically or partially vertically on a portion of a support wall (e.g., rear wall 120) (e.g., may not extend fully between the top wall 112 and the bottom wall 114). In other embodiments, the lift device 100 does not include a full housing, but includes only, at least, a support wall (e.g., rear wall 120). In other embodiments, the lift device 100 includes another suitable number of rail guides, which can be otherwise oriented or configured.

In an exemplary embodiment, the lift device 100 includes at least one rail (as shown in at least FIG. 3). For example, the lift device 100 includes a first rail 134 and a second rail 136. In an exemplary embodiment, the first rail 134 couples with the first rail guide 130, for example to support or stabilize one or more components of the lift device 100 (e.g., a bearing rail block) or components coupled thereto (e.g., a chamber), and the second rail 136 couples with the second rail guide 132, for example to support or stabilize one or more components of the lift device 100 (e.g., a bearing rail block) or components coupled thereto (e.g., a chamber). In an exemplary embodiment, the first rail 134 or the second rail 136 extends between walls of the housing 110. For example, the first rail 134 or the second rail 136 extend (e.g., vertically) between the top wall 112 and the bottom wall 114 (as shown in at least FIG. 3). In some embodiments, the first rail 134 or the second rail 136 are formed of, or integrated with, one or more components of the lift device 100, for example the first rail guide 130 or the second rail guide 132, respectively. In this regard, in some embodiments the first rail 134 or the second rail 136 are coupled with, or integrated into, one or more walls of the housing 110, for example the rear wall 120. In other embodiments, the lift device 100 includes another suitable number of rail guides, which can be otherwise oriented or configured.

According to an exemplary embodiment, the lift device 100 includes a drive shaft 140. The drive shaft 140 couples or cooperates with one or more components of the lift device 100 (e.g., a carrier plate), for example to facilitate movement of components of the lift device (e.g., a carrier plate) or components coupled thereto (e.g., a chamber). In an exemplary embodiment, the drive shaft 140 defines an axis of movement of one or more components of the lift device 100. For example, the drive shaft 140 can define a translational axis, and one or more components of the lift device 100 can move along, or relative to, the translational axis. In an exemplary embodiment, the drive shaft 140 is configured to move (e.g., via a drive motor). For example, the drive shaft 140 can be configured to rotate about an axis (e.g., the translational axis). In an exemplary embodiment, the drive shaft 140 includes a threaded exterior surface. For example, the drive shaft 140 includes a threaded exterior surface to convert movement of the drive shaft 140 (e.g., rotational movement about the translational axis) to movement of one or more components of the lift device 100 (e.g., vertical movement of a carrier plate along the translational axis, as described below). In an exemplary embodiment, the drive shaft 140 extends (e.g., vertically) parallel to at least a portion of the at least one rail guide/rail. The drive shaft 140 is spaced a distance from a wall of the housing (e.g., the rear wall 120), for example to facilitate coupling or movement of components of the lift device 100 (e.g., a carrier plate). In other embodiments, the drive shaft 140 includes additional, fewer, or different components that can be configured to facilitate movements of one or more components of the lift device 100.

In an exemplary embodiment, the lift device 100 includes a drive motor 142. The drive motor 142 couples one or more components of the lift device 100, for example to facilitate movement of components of the lift device 100 (e.g., a carrier plate) or components coupled thereto (e.g., a chamber). The drive motor 142 may be an electric motor, a servomotor, an actuator, or another suitable output device. In an exemplary embodiment, the motor is a brushless DC motor. The motor may be analog or digital. In an exemplary embodiment, the motor has an output of 100 W (⅛ HP) at 24 VDC and a parallel shaft gearhead.

In an exemplary embodiment, the drive motor 142 is coupled with the drive shaft 140, and is configured to move the drive shaft 140 to facilitate movement of one or more components of the lift device 100 (e.g., a carrier plate). For example, the drive motor 142 is coupled with the drive shaft 140, and rotates the drive shaft 140 about an axis (e.g., the translational axis). In other embodiments, the drive motor 142 is coupled with, or configured to move, another component of the lift device 100 (e.g., a carrier plate, etc.) in another direction or orientation. In an exemplary embodiment, the drive motor 142 is coupled with a wall of the housing 110. In the embodiment shown, the drive motor 142 is coupled with the top wall 112 of the housing 110.

According to an exemplary embodiment, the lift device 100 also includes a carrier plate 150. The carrier plate 150 couples one or more components of the lift device 100, and the carrier plate 150 can be configured to move to facilitate movement of components coupled thereto (e.g., a chamber). For example, the carrier plate 150 is coupled with the drive shaft 140, and the carrier plate 150 is configured to translate along the translational axis (e.g., via the drive shaft 140). In an exemplary embodiment, the carrier plate 150 is configured to move (e.g., vertically) from a first position to a second position. For example, the carrier plate 150 translates between a first position, where the carrier plate 150 is a first distance from a wall of the housing 110 (e.g., the top wall 112), and a second position, where the carrier plate 150 is a second distance from the wall of the housing 110 (e.g., the top wall 112). In an exemplary embodiment, when the carrier plate 150 is in the first position, the carrier plate 150 is further from the top wall 112 compared to when the carrier plate 150 is in the second position.

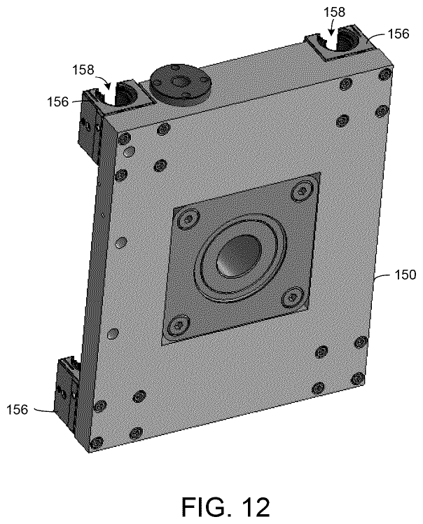

Referring now to FIGS. 12-14, in an exemplary embodiment, the carrier plate 150 includes at least one drive shaft connector, shown as at least one nut (e.g., threaded connector). For example, the carrier plate 150 includes a first nut 152 and a second nut 154. The first nut 152 and/or the second nut 154 couple one or more components of the lift device 100, for example to facilitate movement of the carrier plate 150 or components coupled thereto (e.g., a chamber). In an exemplary embodiment, the first nut 152 and/or the second nut 154 are coupled with the drive shaft 140, and is/are configured to facilitate movement of the carrier plate 150 along the translational axis. For example, the first nut 152 or the second nut 154 can convert movement of the drive shaft 140 (e.g., rotational movement of the drive shaft 140 about the translational axis) to movement of the carrier plate 150 (e.g., vertical movement of the carrier plate 150 along the translational axis). In an exemplary embodiment, the first nut 152 and/or the second nut 154 include a threaded interior surface, which complement the threaded exterior surface of the drive shaft 140. For example, a threaded interior surface of the first nut 152 and/or the second nut 154 mate with a threaded exterior surface of the drive shaft 140. In response to movement of the drive shaft 140 (e.g., rotational movement about the translational axis), the interior threading of the first nut 152 or the second nut 154 mate with the exterior threading of the drive shaft 140, thereby causing movement of the carrier plate 150 (e.g., vertical movement of the carrier plate along the translational axis).

In an exemplary embodiment, the first nut 152 and the second nut 154 are positioned at opposing sides of the carrier plate 150. For example, the first nut 152 is positioned at a top edge of the carrier plate 150, and the second nut 154 is positioned at a bottom edge of the carrier plate 150. The first nut 152 and the second nut 154 are aligned, for example such that the first nut 152 and the second nut 154 are co-axial. In an exemplary embodiment, the first nut 152 or the second nut 154 are received in one or more bores (e.g., opening, hole, orifice) in the carrier plate 150. For example, the first nut 152 is received in a first bore at a top edge of the carrier plate 150, and the second nut 154 is received in a second bore at a bottom edge of the carrier plate 150. In some embodiments, the first nut 152 and/or the second nut 154 are otherwise coupled with the carrier plate 150 (e.g., via a flange, a block, an extension). In other embodiments, the first nut 152 and/or the second nut 154 are otherwise positioned or configured so as to facilitate movement of the carrier plate 150.

In an exemplary embodiment, the carrier plate 150 includes one or more rail blocks. For example, the carrier plate 150 includes a rail block 156 positioned at each of the four corners of the carrier plate 150. The one or more rail blocks couple one or more components of the lift device 100, for example to facilitate movement of the carrier plate 150 or components coupled thereto (e.g., a chamber). In an exemplary embodiment, the one or more rail blocks 156 are coupled with the first rail 134 and/or the second rail 136, and is/are configured to facilitate movement of the carrier plate 150 along a translational axis. For example, the rail blocks 156 are configured with a coordinating structure to receive at least a portion of the first rail 134 or second rail 136 therein. For example, as shown in FIG. 14, the rail blocks 156 include a cylindrical bore 158 to complement the cylindrical shape of the first/second rails 134/136.

Certain elements and configurations of the lift system, according to an exemplary embodiment, address a need for a smooth and quiet transition from a first vertical position to a second vertical position of the chamber. For example, coupling the at least one rail guide (e.g., the first rail guide 130 and/or second rail guide 132) and the at least one rail (e.g., the first rail 134 and/or the second rail 136) to the rear wall 120 of the housing 110 reduces oscillations that may be present in other lift systems where the rails that guide the vertical translation are coupled only at a top and bottom of the rail. Furthermore, the presence of the first nut 152 and the second nut 154 to guide the carrier plate also reduce oscillations of the plate and components during translation along the drive shaft 140. According to an exemplary embodiment, the lift system allows for the vertical movement of the chamber with a noise level of less than ninety decibels (90 dB).

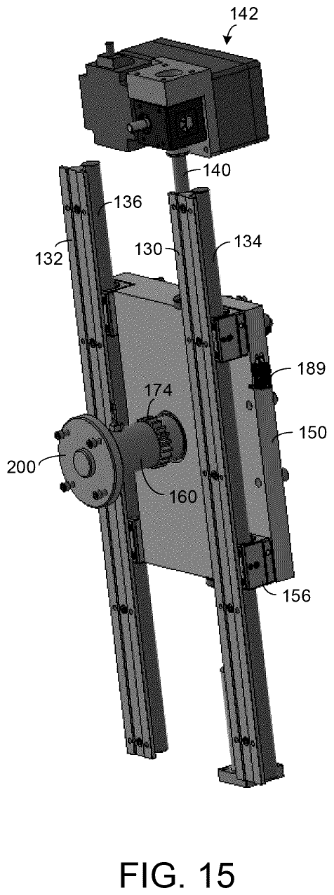

Referring now to FIG. 15, in an exemplary embodiment, the carrier plate 150 is coupled to a shaft 160. The shaft 160 couples to one or more components of the lift device 100, for example to facilitate movement of components coupled thereto (e.g., a chamber). In an exemplary embodiment, a cylindrical passage (e.g., a bore) is formed through the carrier plate 150 for passage of the shaft 160 therethrough. A first end of the shaft 160 is coupled to the locking plate 168 on a front side of the carrier plate 150 (not shown, described in greater detail below). A second end of the shaft is a connecting end. In an exemplary embodiment, the connecting end forms a bracket 200 (e.g., plate, clasp, hook) configured to couple to the carrying basket 190. In other embodiments, the connecting end or bracket 200 is configured to couple directly to the chamber being lifted. Between the first end and the second end, the shaft 160 passes through the passage in the carrier plate 150 and through the slot 122 in the housing 110. Movement of the carrier plate 150 from a first vertical position to a second vertical position (as described above), causes movement of the shaft 160, and consequently, the chamber coupled thereto to also move from the first vertical position to the second vertical position. In other words, vertical movement of the shaft 160 is facilitated by movement of the carrier plate 150.

Referring now to FIGS. 16-18, the lift device 100 further includes the rotating system configured for changing an orientation of the chamber. In an exemplary embodiment, the shaft 160 is a rotating shaft (e.g., rotates along a longitudinal axis of the shaft). The rotation of the shaft 160 causes a change in orientation of the connecting end, and therefore, a change in orientation of the bracket and any component coupled thereto (e.g., a chamber). In an exemplary embodiment, the shaft rotates approximately 90 degrees to facilitate a change in orientation of the chamber from a first orientation (e.g., a horizontal orientation) to a second orientation (e.g., a vertical orientation).

According to an exemplary embodiment, the lift device 100 (e.g., the rotating system) includes a rack 170 and pinion 174 system, as shown in FIG. 16. The rack 170 and pinion 174 couple one or more components of the lift device 100, for example to facilitate movement (e.g., rotation, change in orientation) of components coupled to the lift device 100 (e.g., a chamber). According to an exemplary embodiment, a rack 170 having a plurality of teeth 172 is positioned in a notch 124 formed in the slot 122 in the rear wall 120 of the housing 110. The pinion gear 174, having a plurality of teeth 176, is positioned at a corresponding location on the shaft 160 (e.g., positioned at a location along the longitudinal length of the shaft at a location aligned with the slot 122 and notch 124 of the housing 110) such that the teeth 176 can interact with the teeth 172 of the rack 170. In use, as the lift device 100 causes the carrier plate 150 and the shaft 160 to move from a first vertical position to a second vertical position (as described above), the pinion 174 passes the rack 170 and the engagement of teeth 172 and 176 cause rotation of the shaft 160. Rotation of the shaft 160 results in a change in orientation of the bracket 200 and the chamber from a first orientation to a second orientation (e.g., horizontal to vertical orientation). In an exemplary embodiment, the rack 170 includes three teeth 172. In other embodiments, a different number of teeth and/or a different shape and size of teeth 172, 176 may be used. In an exemplary embodiment, the teeth 172 and 176 are designed to cooperate in such a way to cause a rotation of approximately 90 degrees of the shaft 160.

According to an exemplary embodiment, the lift device 100 includes a limit arm 178, shown in the rear view of locking plate 168 shown in FIG. 17. The limit arm 178 is coupled at a first end to the rotating shaft 160. For example, the first end of the limit arm 178 includes an aperture 180 for receiving portion of the rotating shaft 160 therethrough. According to an exemplary embodiment, the aperture 180 is shaped (e.g., keyed) to correspond with a shape (e.g., keyed shape) of a portion of the shaft 160 such that the limit arm 178 moves (e.g., swings radially) with rotation of the shaft 160. A second end of the limit arm 178 includes a locking pin 182. The guide pin extends from a surface of the limit arm 178 such that it can be received within a limit slot 184 formed in the locking plate 168. In an example, the limit slot 184 follows a curved trajectory (e.g., forming a quarter of a circle). As the shaft 160 rotates, which causes the limit arm 178 to swing, the locking pin 182 moves along the limit slot 184.

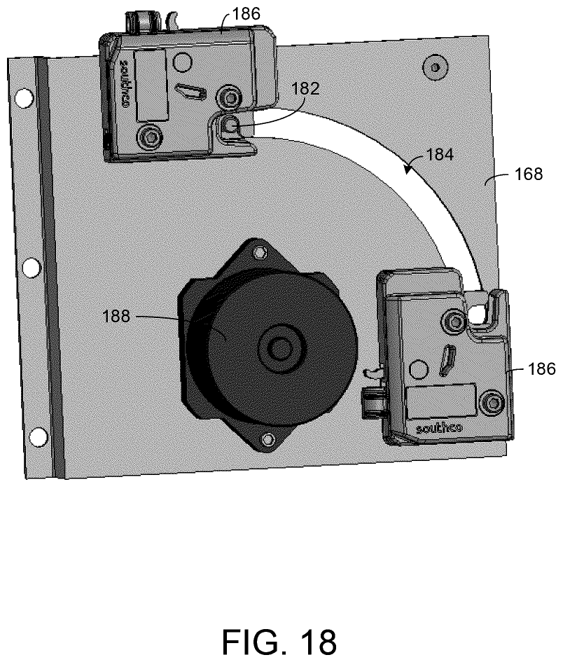

According to an exemplary embodiment, the lift device (e.g., the rotating system) includes at least one locking mechanism 186 (shown in FIG. 18). For example, there may be a locking mechanism at each end of the limit slot 184. In an embodiment, the locking mechanism 186 is an electronic rotary latch configured to receive and secure the locking pin 182 in a position in the limit slot 184. The securing of the locking pin 182 by the rotary latch prevents swinging of limit arm 178, which prevents rotation of the shaft 160, and ultimately, maintains the chamber in its present orientation (e.g., in a horizontal or vertical orientation). To further prevent rotation of the shaft 160 when it is in a locked position, the first end of the shaft 160 is coupled to a dashpot 188 (e.g., a damper) to resist motion (e.g., by friction) of the shaft 160. In an example, the locking mechanism 186 (e.g., the rotatory latch) and dashpot 188 are configured to securely maintain the chamber in a lifted and vertical orientation for use with the mixing apparatus 50. According to an embodiment, each electronic rotary latch is controlled (e.g., locked/unlocked) by a normally closed limit switch 189. The limit switch 189 includes a lever roller ball that rides on a ramp to disengage the limit switch 189 to power on to power off, which activates/deactivates the locking mechanism.

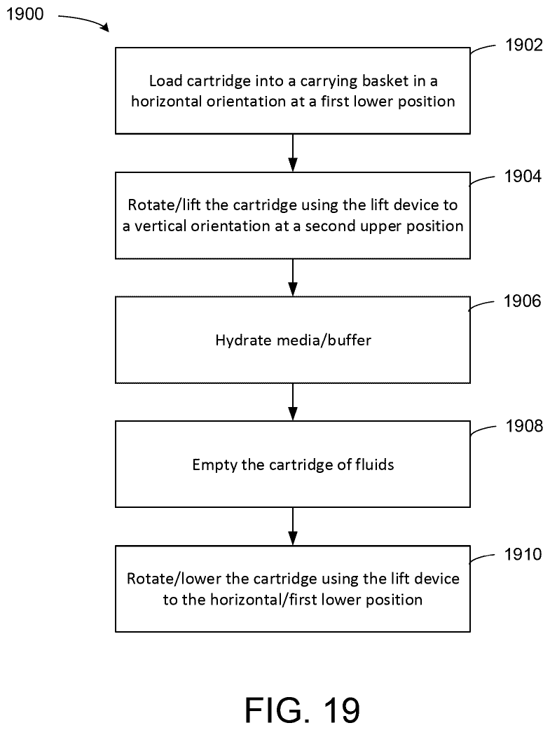

Referring to FIG. 19, according to an exemplary, the above described lift device 100 may be used during a method 1900 of hydrating a dry culture media or other powders. In step 1902, the cartridge is loaded into a carrying basket in a horizontal orientation at a first lower position. In step 1904, the cartridge is rotated and lifted using the lift device (as described herein) to a vertical orientation at a second upper position. In step 1906, the media or buffer is hydrated. In step 1908, fluids are emptied from the cartridge. And in step 1910, the cartridge is rotated and lowered using the lift device (as described herein) to return to the horizontal orientation at the first lower position.

In other embodiments, the above described lifting and rotating mechanisms are employed during hydration of dry culture media or other powders. According to an exemplary embodiment, a method for hydration of a powder housed in a chamber or cartridge includes, during media/buffer hydration by the mixing apparatus, using the lifting and rotating mechanisms to rock and/or swirl the chamber/cartridge to facilitate dissolution of the powder. The rocking/swirling may be continuous throughout the hydration process or may be alternated with other hydration steps (e.g., pressure pulsing as described in U.S. Pat. No. 10,150,941, entitled “Media Mixing Chamber”, which is incorporated by reference herein in its entirety).

In another embodiment, the above described lifting and rotating mechanisms are used to adjust the orientation of the mixing chamber/media cartridge during dissolution of powder (e.g., for preparation of cell culture media solution from powder). According to this embodiment, a method for facilitating dissolution of powder using a mixing apparatus (e.g., one having a media mixing chamber similar to those described in U.S. Pat. No. 10,150,941) includes one or both steps of (a) orienting a mixing chamber in a substantially vertical position during one phase of hydration/dissolution and (b) rotating the mixing chamber to a substantially non-vertical position during another phase of hydration/dissolution. By thus rotating the mixing chamber, the fluid flow characteristics within the chamber may be altered and help to break up buildup of dry clumps without excessively agitating the chamber (which may undesirably result in excess foaming).

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary

It is important to note that any element disclosed in one embodiment may be incorporated or utilized with any other embodiment disclosed herein.

What is claimed is:

1. A lift device comprising:
a first rail guide coupled vertically to a support wall;
a rail coupled to the first rail guide;
a carrier plate coupled to the rail by at least one linear bearing rail block coupled to the carrier plate and the rail, the at least one linear bearing rail block configured to move along a length of the rail;
a threaded drive shaft extending parallel to the first rail guide, through the carrier plate, and coupled to the carrier plate at a top edge and a bottom edge of the carrier plate; and
a drive motor coupled with the drive shaft, wherein the drive motor drives movement of the carrier plate along the drive shaft.

2. The lift device of claim 1, further comprising a second rail guide coupled vertically to the rear wall, separated from the first rail guide, and a second rail coupled to the second rail guide.

3. The lift device of claim 2, wherein the at least one linear bearing rail block comprises four linear bearing rail blocks, and wherein each linear bearing rail block is coupled to a corner of the carrier plate and configured to translate along a respective one of the first rail guide and the second rail guide.

4. The lift device of claim 1, wherein the first rail guide is securely coupled to the support wall and the rail is securely coupled to the first rail guide to minimize oscillations and produce a sound that is less than 90 decibels.

5. The lift device of claim 1, wherein the drive shaft is coupled to the carrier plate by at least one threaded connector.

6. The lift device of claim 1, wherein the carrier plate is coupled to a carrying basket.

7. The lift device of claim 6, wherein the carrying basket is configured to receive a cylindrical cartridge, wherein the cylindrical cartridge comprises a mass of approximately 6.5 kg when empty and approximately 56.5 kg when carrying powder contents.

8. The lift device of claim 6, wherein the carrier plate is coupled to the carrying basket by a shaft extending between the carrier plate and the carrying basket.

9. The lift device of claim 8, wherein the shaft is rotatable relative to the carrier plate and is configured to allow a change in orientation of the carrying basket.

10. A device for changing an orientation of a carrying basket, the device comprising:
a support wall including an elongated slot, the elongated slot including a notch supporting a rack;
a rail coupled to the support wall;
a carrier plate coupled to the rail, the carrier plate configured to move between a first position and a second position along the rail; and
a rotatable shaft carrying a pinion gear, the pivot shaft extending between the carrier plate and the carrying basket, and configured to rotate about a rotational axis;
wherein the rotatable shaft passes through the elongated slot in the support wall;
wherein as the carrier plate moves between the first position and the second position, the pinion gear moves into engagement with the rack thereby causing the rotatable shaft to rotate about the rotational axis; and
wherein rotation of the pivot shaft causes the carrying basket to change from a first orientation to a second orientation.

11. The device of claim 10, wherein the rack comprises three teeth configured to cooperate with teeth of the pinion gear.

12. The device of claim 10, further comprising a limit arm coupled with and extending radially from the shaft, the limit arm having a pin and the arm configured to swing radially about the rotational axis.

13. The device of claim 12, further comprising a locking plate coupled to the carrier plate, the locking plate having a limit slot configured to receive the pin, such that the pin moves along the limit slot as the arm swings radially about the rotational axis.

14. The device of claim 13, wherein the locking plate further comprises a locking mechanism, the locking mechanism configured to receive the locking pin to maintain a position of the arm and prevent rotation of the shaft and the carrying basket.

15. The device of claim 10, wherein the pinion gear is configured to engage the rack to rotate the pivot shaft about the rotational axis approximately 90 degrees.

16. A device for lifting and orienting a cylindrical cartridge, the device comprising:
a lift mechanism configured to move the cylindrical cartridge from a first vertical position to a second vertical position; and
a rotating mechanism configured to move the cylindrical cartridge from a first orientation to a second orientation;
wherein the lift mechanism and the rotating mechanism work to lift and change the orientation of the cylindrical cartridge.

17. The device of claim 16, wherein the first orientation of the cylindrical cartridge is a horizontal orientation and the second orientation of the cylindrical cartridge is a vertical orientation.

18. The device of claim 16, wherein the lift mechanism comprises:
a rail guide coupled vertically to a support wall;
a rail coupled to the rail guide;
a carrier plate coupled to the rail by at least one linear bearing rail block coupled to the carrier plate and the rail, the at least one linear bearing rail block configured to move along a length of the rail;
a threaded drive shaft extending parallel to the rail, through the carrier plate, and coupled to the carrier plate at a top edge and a bottom edge of the carrier plate; and
a drive motor coupled with the drive shaft, wherein the drive motor drives movement of the carrier plate along the drive shaft.

19. The device of claim 16, wherein the rotating mechanism comprises:
a support wall including an elongated slot, the elongated slot including a notch supporting a rack;
a rail coupled to the support wall;
a carrier plate coupled to the rail, the carrier plate configured to move between a first position and a second position along the rail; and
a rotatable shaft carrying a pinion gear, the rotatable shaft extending between the carrier plate and the cylindrical cartridge, and configured to rotate about a rotational axis;
wherein the rotatable shaft passes through the elongated slot in the support wall;
wherein as the carrier plate moves between the first position and the second position, the pinion gear moves into engagement with the rack thereby causing the rotatable shaft to rotate about the rotational axis; and
wherein rotation of the pivot shaft causes the cylindrical cartridge to change from the first orientation to the second orientation.

20. The device of claim 16, wherein the lift mechanism and the rotating mechanism work to lift and rotate the cylindrical cartridge simultaneously.
